(19) United States
(12) Patent Application Publication
(10) Pub. No.: US 2004/0197669 A1
(43) Pub. Date: Oct. 7, 2004

(54) Electrolyte for use in phosphate based lithium ion/polymer cells

(76) Inventors: Eileen Saidi, Henderson, NV (US); Jon Parke, Henderson, NV (US)

Correspondence Address: VALENCE TECHNOLOGY, INC., 301 Conestoga Way, Henderson, NV, 89015, US

(21) Appl. No.: 10/762,846

(22) Filed: Jan. 21, 2004

Related U.S. Application Data
(60) Provisional application No. 60/442,240, filed on Jan. 22, 2003.

(51) Int. Cl. H01M 10/40; H01M 4/58

(52) U.S. Cl. 429/331; 429/332; 429/231.95; 429/231.6; 429/221

(57) ABSTRACT

This invention relates to electrolytes containing ethyl methyl carbonate as a solvent for use in lithium cells or batteries containing metal phosphate cathodes. The invention further relates to electrolytes comprising ethyl methyl carbonate, ethylene carbonate, diethyl carbonate and propylene carbonate for use in lithium cells or batteries with metal phosphate cathodes, and to batteries employing such electrolytes. The electrolytes of the present invention are an improvement over other electrolytes used in lithium cells or batteries with metal phosphate cathodes in that the electrolytes are less prone to gassing and therefore have better shelf stability.

This application claims priority under 35 U.S.C. §119(e) to U.S. provisional application Ser. No. 60/442,240 filed Jan. 22, 2003.

### FIELD OF THE INVENTION

This invention relates to electrolytes containing ethyl methyl carbonate as a solvent for use in lithium batteries, including lithium metal, lithium ion and lithium ion polymer batteries with metal phosphate cathodes. This invention further relates to electrolytes comprising ethyl methyl carbonate, ethylene carbonate, diethyl carbonate and propylene carbonate for use in lithium batteries, including litium metal, lithium ion and lithium ion polymer batteries, with metal phosphate cathodes, and to batteries employing such electrolytes. The electrolytes of the present invention are an improvement over other electrolytes used in lithium batteries with metal phosphate cathodes in that the electrolytes are less prone to gassing and therefore have better shelf stability.

### BACKGROUND OF THE INVENTION

The proliferation of portable electronic devices such as cell phones and laptop computers has lead to an increased demand for high capacity, long endurance light weight batteries. Because of this, alkali metal batteries, especially lithium ion batteries, have become a useful and desirable energy source. Lithium metal, sodium metal and magnesium metal batteries are also well known and desirable energy sources.

By way of example and generally speaking, lithium batteries are prepared from one or more lithium electrochemical cells containing electrochemically active (electroactive) materials. Such cells typically include, at least, a negative electrode, a positive electrode, and an electrolyte interposed between the positive and negative electrodes.

Lithium ion batteries are well known. Lithium ion batteries have an insertion anode, such as a lithium metal chalcogenide, lithium metal oxide, coke or graphite. These types of electrodes are typically used with lithium-containing insertion cathodes to form an electroactive couple in a cell. The resulting cells are not charged in an initial condition. Before this type of cell can be used to deliver electrochemical energy, it must be charged. In the charging operation, lithium is transferred from the lithium-containing electrode cathode to the negative electrode. During discharge the lithium is transferred from the negative electrode back to the positive electrode. During a subsequent recharge, the lithium is transferred back to the negative electrode where it reinserts. Thus with each charge/discharge cycle, the lithium ions (Li⁺) are transported between the electrodes. Such rechargeable batteries are called rechargeable lithium ion batteries or rocking chair batteries.

In order for the lithium ion battery to be successful it requires the use of an electrolyte that has a high ionic conductivity in order to sustain good performance at reasonable charge/discharge rates. The electrolyte needs to be electrochemically stable while delivering acceptable cycle life and to exhibit stability during storage while being cost effective. The performance of the lithium ion batteries is greatly affected by the quality of the electrolyte. Therefore, the battery industry is constantly attempting to improve the qualities and properties of electrolytes.

Various linear and cyclic carbonates have been used as electrolyte solvents in conventional lithium ion batteries. When used with suitable solutes to form electrolytes, such electrolytes generally have relatively good ionic conductivities. Generally, such electrolytes consist of a metal salt dispersed in nonaqueous solvents or polymers. For example, dimethyl carbonate is commonly used in electrolytes in lithium ion batteries. It is has a relatively low viscosity, is used as a viscosity reducer and hence a conductivity enhancer. However, dimethyl carbonate can react on lithiated carbon anodes to form gaseous by-products. This is problematic in cells, especially in cells with flexible packaging. This problem is commonly referred to as gassing.

Thus research is continually ongoing to understand such undesired side reactions with cell components and the reaction mechanism. Efforts are made to select solvents and salts which are less reactive with cell components while maintaining cell performance. Determining methods to prevent undesired side reactions, especially those involving formation of gas in cells containing lithium metal phosphate cathodes, has been challenging.

Thus, alternative highly conductive electrolytes for use in modern batteries are constantly being sought. The electrolytes of the present invention are beneficial in that they avoid gassing in cells containing lithium metal phosphate cathodes while maintaining high conductivity and good chemical and thermal stability.

### SUMMARY OF THE INVENTION

The present invention relates to electrolytes containing ethyl methyl carbonate as a solvent for use in lithium batteries, including lithium metal batteries, lithium ion batteries and lithium ion polymer batteries with metal phosphate cathodes. The invention further relates to electrolytes comprising a quaternary solvent system comprised of ethyl methyl carbonate (EMC), ethylene carbonate (EC), diethyl carbonate (DEC) and propylene carbonate (PC) for use in lithium batteries, including lithium metal batteries, lithium ion batteries and lithium ion polymer batteries with metal phosphate cathodes, and to batteries employing such electrolytes. The electrolytes of the present invention are an improvement over other electrolytes used in lithium batteries with metal phosphate cathodes in that the electrolytes are less prone to gassing and therefore have better shelf stability.

A preferred embodiment of the present invention relates to an electrolyte comprised of a metal salt and a quaternary solvent system wherein the quaternary solvent system is comprised of ethylene carbonate, propylene carbonate diethyl carbonate and ethyl methyl carbonate. The ethylene carbonate is preferably present in an amount from about 20 to about 80 weight (wt) %. The propylene carbonate is preferably present in an amount from about 0 to about 20 wt %. The ethyl methyl carbonate is preferably present in an amount from about 10 to about 80 wt % and the diethyl carbonate is preferably present in an amount from about 0 to about 30 wt %. (The percentages of these four components is given as the weight percentage of the four component solvent. The use of % with these four components herein is hereby the weight percentage of the four component solvent throughout this application.) Such electrolytes have been found to be highly conductive and reduce formation of gaseous by-products formed by unwanted side reactions between the electrolyte and other components of the batteries.

The invention also relates to batteries or cells containing the electrolytes of the present invention. Such batteries and cells are comprised of a cathode which is comprised of a metal phosphate and more preferably a lithium metal phosphate. Preferred embodiments of cathodes useful in the present invention are cathodes wherein the active material is LiMgₓFe₁₋ₓPO₄ wherein x is greater than about 0.01 and is less than about 0.15 or a lithium vanadium phosphate active material.

### BRIEF DESCRIPTION OF THE DRAWINGS

FIG. 1 shows the cycling performance of the electrolyte solutions of the present invention.

FIG. 2 shows that acceptable cycle life can be achieved using the electrolytes of the present invention.

### DETAILED DESCRIPTION OF THE INVENTION

As stated above the present invention relates to electrolytes containing ethyl methyl carbonate as a solvent for use in lithium batteries, including lithium metal batteries, lithium ion batteries and lithium ion polymer batteries with metal phosphate cathodes. The invention further relates to electrolytes comprising a quaternary solvent system comprised of ethyl methyl carbonate (EMC), ethylene carbonate (EC), diethyl carbonate (DEC) and propylene carbonate (PC) for use in lithium batteries with metal phosphate cathodes, and to batteries employing such electrolytes. The electrolytes of the present invention are an improvement over other electrolytes used in lithium batteries with metal phosphate cathodes in that the electrolytes are less prone to gassing and therefore have better shelf stability.

A preferred embodiment of the present invention relates to an electrolyte comprised of a metal salt and a quaternary solvent system wherein the quaternary solvent system is comprised of ethylene carbonate, propylene carbonate, diethyl carbonate and ethyl methyl carbonate. The ethylene carbonate is preferably present in an amount from about 20 to about 80 wt %. The propylene carbonate is preferably present in an amount from about 0 to about 20 wt %. The ethyl methyl carbonate is present in an amount from about 10 to about 80 wt % and the diethyl carbonate is preferably present in an amount from about 0 to about 30 wt %. Such electrolytes have been found to be highly conductive and reduce formation of gaseous by-products formed by unwanted side reactions between the electrolyte and other components of the batteries or cells.

The invention also relates to batteries or cells containing the electrolytes of the present invention. Such batteries and cells are comprised of a cathode which is comprised of a metal phosphate and more preferably a lithium metal phosphate. In a preferred embodiment of the present invention the cathodes are cathodes wherein the active material is LiMgₓFe₁₋ₓPO₄ wherein 0.01≦x≦0.15 or a lithium vanadium phosphate active material.

Dimethyl carbonate is commonly used in electrolytes in lithium batteries as a viscosity reducer to enhance conductivity. However, dimethyl carbonate has a low boiling point and can react on lithiated carbon anodes to form gaseous CH₄ and C₂H₆. This can be problematic in cells with flexible packaging in that the gases become trapped in the flexible packaging and with enough gassing the flexible packaging can distort or burst.

Ethyl methyl carbonate (EMC), also known as methyl ethyl carbonate (MEC), is less volatile than dimethyl carbonate. EMC is less likely to break down and hence less prone to gas generation. However, it has also been found that direct substitution of dimethyl carbonate with longer chain carbonates is not successful in all cells in that when such a substitution is made cycling performance may be adversely affected. By way of example, substitution of diethyl carbonate for dimethyl carbonate in a lithium ion call has shown an unacceptable capacity fade over cycle life.

Lithium ion batteries represent a growing segment of the battery industry because of their high electrochemical potential and high performance capabilities. Some lithium ion and lithium ion polymer batteries have demonstrated high energy density, high voltage and excellent pulse capability.

A specific example of a lithium ion battery is a lithium ion polymer battery that utilizes a phosphate based cathode material. Such battery exhibits high energy density, high efficiency, cost effectiveness, safety and is environmentally safe. Such phosphates have recently been developed and offer many benefits over the existing battery materials.

Until development of such phosphate based cathode materials the cell chemistry of lithium ion batteries was limited by the choice of suitable lithium liberating cathode materials, i.e. the three oxide electroactive materials, LiMn₂O₄, LiCoO₂, and LiNiO₂. These materials although relatively expensive to produce are generally found to exhibit high electrochemical performance.

The phosphate materials employed in the battery of the present invention may be classified as materials built up from one or more phosphate (PO₄) tetrahedron or from the condensation of several PO₄ groups sharing, one, two or three oxygens. When atoms such as F, Cl, S and H replace one or more of the oxygen atoms in the phosphates, substituted phosphates are created.

The most common form of phosphate, the monophosphates, are salts derived from the orthophosphoric acid, H₃PO₄. These salts are characterized by a simple isolated PO₄³⁻ group comprising a central phosphorous atom surrounded by four oxygen atoms at the comers of an almost regular tetrahedron. The physical and chemical properties of the monophosphates have been well documented and they are considered to be both chemically and thermally very stable.

Another class of monophosphates is the transition metal phosphates. Such transition metal phosphates, and in particular lithiated metal phosphates, have recently been introduced as cathode active materials for lithium ion batteries. These transition metal phosphates are insertion type compounds like their oxide based counterparts.

The transition metal phosphates allow great flexibility in design of lithium ion batteries. Simply by changing the identity of the transition metal allows for regulation of voltage and specific capacity of the active materials. Such active materials are disclosed and described in U.S. Ser. No. 09/484799 (filed Jan. 18, 2000), U.S. Ser. No. 09/484919 (filed Jan. 18, 2000), U.S. Ser. No. 10/116276 (filed Apr. 3, 2002), U.S. Ser. No. 10/116450 (filed Apr. 3, 2002) and U.S. Ser. No. 10/115802 (filed Apr. 3, 2002) hereby incorporated herein by reference. Doped lithium metal phosphates useful in the present invention include, but are not limited to, lithium metal phosphates disclosed in U.S. Pat. No. 6,387,568 issued May 14, 2002 and U.S. Ser. No. 10/014822 filed Oct. 26, 2001. Lithium vanadium phosphates, a particular class of transition metal phosphates, useful in the present invention, include but are not limited to, the lithium vanadium phosphates disclosed in U.S. Pat. No. 5,871,866 issued Feb. 16, 1999; U.S. Pat. No. 5,908,716 issued Jun. 1, 1999; U.S. Pat. No. 6,136,472 issued Oct. 24, 2000; U.S. Pat. No. 6,153,333 issued Oct. 28, 2000; U.S. Pat. No. 6,387,568 issued May 14, 2002; U.S. Pat. No. 6,447,951 issued Sep. 10, 2002; WO 01/54212 published Jul. 26, 2001; and U.S. Ser. No. 10/014822 filed Oct. 26, 2001 and hereby incorporated herein by reference. Physical mixtures of all of the above listed active cathode materials can also be employed. The most preferred cathode active material is a material having the formula LiFe₁₋ₓMgₓPO₄ wherein x is from about 0.01 to about 0.15. Other preferred cathode active materials are lithium vanadium phosphate materials, such as Li₃V₂(PO₄)₃ or materials of the formula LiMₓFe₁₋ₓPO₄ wherein M is selected from the group consisting of Zr, Ti, Nb, Mg, Zn and Ca.

A battery produced using a transition metal phosphate and a plasticized polymer electrolyte, that eliminates free liquid in the battery cell, is herein known as a lithium ion polymer battery. Such a battery since it does not contain a liquid electrolyte can be packaged in foil. Such a package design is beneficial in that it significantly reduces battery weight and enhances design flexibility.

A battery recently produced using a lithium transition metal phosphate and an electrolyte of 2:1 (by weight) of ethylene carbonate and dimethyl carbonate with 1M LiPF₆ salt in a flexible package was prone to gassing. Various solutions were sought to rectify such problem. One such solution that was considered was the use of ethyl methyl carbonate and elimination of the use of the dimethyl carbonate. Ethyl methyl carbonate is less volatile than dimethyl carbonate and is also less prone to breakdown and gas generation.

Additional experimentation resulted in the additional discovery of the quaternary solvent system electrolytes of the present invention which find use as electrolytes in such metal phosphate batteries. Substitution of dimethyl carbonates with longer chain carbonates such as ethyl methyl carbonate has not always been successful as cycling performance can be degraded. However, it has now been found that ethyl methyl carbonate can successfully be used as a substitute for dimethyl carbonate in metal phosphate batteries without degrading cycling performance. Ethyl methyl carbonate has now been successfully employed in a lithium metal phosphate battery while preserving conductivity and cell performance.

The following terms and abbreviations as used herein have the definitions and meaning described below:

DEC: diethylcarbonate

DMC: dimethyl carbonate

EC: ethylene carbonate

EMC: ethyl methyl carbonate (=MEC)

MEC: methyl ethyl carbonate (=EMC)

PC: propylene carbonate

μm: microns

wt: weight

As used herein “battery” refers to a device comprising one or more electrochemical cells for the production of electricity. Each electrochemical cell comprises an anode, a cathode and an electrolyte.

As used herein the terms “anode” and “cathode” refer to the electrodes at which oxidation and reduction occur, respectively, during battery discharge. During charging of the battery, the sites of oxidation and reduction are reversed.

As used herein the words “preferred” and “preferably” refer to embodiments of the invention that afford certain benefits under certain circumstances. However, other embodiments may also be preferred under the same or other circumstances. Further, the recitation of one or more preferred embodiments does not imply that other embodiments are not useful and is not intended to exclude other embodiments from the scope of the invention.

Electrolytes

The electrolytes of the present invention are prepared by conventional methods known to those skilled in the art. In general, the present invention relates to electrolytes comprising ethyl methyl carbonate for use in batteries comprising metal phosphate cathodes. The present invention further relates to batteries comprised of a metal phosphate cathode which employs such electrolytes. More specifically the electrolytes of the present invention are comprised of ethylene carbonate, propylene carbonate, diethyl carbonate and ethyl methyl carbonate.

The ethylene carbonate is preferably present in an amount from about 20 to about 80 weight (wt) %. The propylene carbonate is preferably present in an amount from about 0 to about 20 wt %. The ethyl methyl carbonate is preferably present in an amount from about 10 to about 80 wt % and the diethyl carbonate is preferably present in an amount from about 0 to about 30 wt %. More preferably the ethyl methyl carbonate is present in an amount from about 10 to about 40 wt %; ethylene carbonate is present in an amount from about 30 to about 70 wt %; propylene carbonate is present in an amount from about 2 to about 20 wt %; and diethyl carbonate is present in an amount from about 2 to about 30 wt %. In another preferred embodiment the ethyl methyl carbonate is present in an amount from about 10 to about 30 wt %; ethylene carbonate is present in an amount from about 50 to about 70 wt %; propylene carbonate is present in an amount from about 2 to about 10 wt %; and diethyl carbonate is present in an amount from about 5 to about 30 wt %.

In another preferred embodiment the ethyl methyl carbonate is present in an amount of about 25 wt %; ethylene carbonate is present in an amount of about 60 wt %; propylene carbonate is present in an amount of about 5 wt %; and diethyl carbonate is present in an amount of about 10 wt %. In another preferred embodiment the ethyl methyl carbonate is present in an amount of about 10 wt %; ethylene carbonate is present in an amount of about 60 wt %; propylene carbonate is present in an amount of about 5 wt %; and diethyl carbonate is present in an amount of about 25 wt %. In another preferred embodiment the ethyl methyl carbonate is present in an amount of about 30 wt %; ethylene carbonate is present in an amount of about 60 wt %; propylene carbonate is present in an amount of about 5 wt %; and diethyl carbonate is present in an amount of about 5 wt %.

In general, polymeric electrolytic cells comprise polymeric film composition electrodes and separator membranes. In particular, rechargeable lithium battery cells comprise a separator that is plasticized by the electrolytes. Lithium ions can move through such polymer electrolyte between the electrodes during the charge/discharge cycles of the cell. In such cells an ion source electrode is a lithium compound or other material capable of intercalating lithium ions. The electrolytes of the present invention are useful in cells containing transition metals as the active material and more preferably containing lithium transition metal phosphates as the active materials. Preferred active materials are lithium vanadium phosphates and LiMgₓFe₁₋ₓPO₄ wherein x is about 0.01 to about 0.15.

An electrode separator membrane comprises a polymeric matrix made ionically conductive by the incorporation of an organic solution of a dissociable lithium salt (solute) which provides ionic mobility. Strong, flexible polymeric electrolytic cell separator materials retain electrolyte lithium salt solutions and remain functional over a wide range of temperatures. These electrolyte membranes are used either in the usual manner as separator elements with mechanically assembled battery cell components, or in composite battery cells constructed of successively coated layers of electrode and electrolyte compositions.

The electrolytes of the present invention exhibit high conductivities, good chemical stability, good mechanical properties, good thermal stability and low toxicity. Cycling tests have shown that the electrolytes of the present invention are useful in lithium batteries wherein the cathode is comprised of an electroactive metal phosphate.

A typical laminated battery in which such electrolyte can be employed includes, but is not limited to, batteries disclosed in the above listed patents. For example a typical bi-cell comprises a negative electrode, a positive electrode, and another negative electrode wherein an electrolyte/separator is interposed between each of the counter electrodes. The negative and positive electrodes each include a current collector. The negative electrode comprises an intercalation material such as carbon or graphite or a low voltage lithium insertion compound, dispersed in a polymeric binder matrix, and includes a current collector, preferably a copper collector foil, preferably in the form of an open mesh grid, embedded in or laid on one side of the negative electrode. A separator is positioned upon the negative electrode on the side opposite of the current collector. A positive electrode comprising a metal phosphate active material is positioned on the opposite side of the separator from the negative electrode. A current collector, preferably an aluminum foil or grid is then positioned on the positive electrode opposite the separator. Another separator is positioned on the side opposite the other separator and then another negative electrode is positioned upon that separator. The electrolyte is then dispersed into the cell using conventional methods known to those skilled in the art. A protective bagging material covers the cell and prevents infiltration of air and moisture. In an alternative embodiment two positive electrodes can be used in place of the two negative electrodes and the negative electrode is then replaced with a positive electrode.

The lithium salt (solute) useful for dispersion in the electrolyte include but are not limited to LiBF₄, LiBF₆, LiAsF₆, LiPF₆, LiClO₄, LiB(C₆H₅)₄, LiAlCl₄, LiBr, LiB(C₆H₅)₄, LiAlCl₄, LiCF₃SO₃, LiN(CF₃SO₂)₂, LiC(CF₃SO₂)₃, LiN(SO₂C₂F₅)₂, Li[B(O₄C₂)]₂ and mixtures thereof. Typical alkali metal salts useful in the present invention include, but are not limited to salts having the formula M⁺X⁻ where M⁺ is an alkali metal cation such as Li⁺, Na⁺, K⁺, and combinations thereof; and X⁻ is an anion such as Cl⁻, Br⁻, I⁻, ClO₄, BF₄⁻, PF₆⁻, AsF₆⁻, SbF₆⁻, CH₃CO₂⁻, CF₃SO₃⁻, N(CF₃SO₂)₂³¹ , N(CF₃SO₂)₂⁻, C(CF₃SO₂)₂⁻ and combinations thereof. Preferably the lithium salt is LiBF₄ or LiPF₆.

Anode materials useful in the batteries of the present invention include, but are not limited to lithium, carbon, graphite, CMS graphite (Shanghai Shanshan Technology), cokes, meso carbons, tungsten oxides, titanates, metal oxides (particularly transition metal oxides), metal phosphates (particularly transition metal phosphates), sulfates, silicates, vanadates, metal chalcogenides and lithium alloys, such as alloys of lithium with aluminum, mercury, manganese, iron, and zinc and physical and chemical mixtures thereof. Preferred anode materials are CMS graphite or carbon, such as coke or graphite, specifically MCMB: mesophase-carbon micro-beads (Osaka Gas Company, Limited, Japan) and MCF: mesophase-pitch based carbon fiber (Petoca Corporation Limited, Japan). However, any electroactive anode material compatible with the disclosed electrolytes can be used.

Active cathode materials useful in the batteries of the present invention include transition metal phosphates, and more preferably lithium transition metal phosphates. The preferred cathode materials are transition metal phosphates including, but not limited to, those disclosed in U.S. Ser. No. 09/484799 (filed Jan. 18, 2000), U.S. Ser. No. 09/484919 (filed Jan. 18, 2000), U.S. Ser. No. 10/116276 (filed Apr. 3, 2002), U.S. Ser. No. 10/116450 (filed Apr. 3, 2002) and U.S. Ser. No. 10/115802 (filed Apr. 3, 2002) hereby incorporated herein by reference. Other preferred cathode materials are lithium vanadium phosphates, including but not limited to, those disclosed in U.S. Pat. No. 5,871,866 issued Feb. 16, 1999; U.S. Pat. NO. 5,908,716 issued Jun. 1, 1999; U.S. Pat. No. 6,136,472 issued Oct. 24, 2000; U.S. Pat. NO. 6,153,333 issued Oct. 28, 2000; U.S. Pat. No. 6,387,568 issued May 14, 2002; U.S. Pat. No. 6,447,951 issued Sep. 10, 2002; WO 01/54212 published Jul. 26, 2001; and U.S. Ser. No. 10/014822 filed Oct. 26, 2001 hereby incorporated herein by reference. Physical mixtures of all of the above listed active cathode materials can also be employed. The most preferred cathode active material is a material having the formula LiFe₁₋ₓMgₓPO₄ wherein x is from about 0.01 to about 0.15. Other preferred cathode active materials are lithium vanadium phosphate materials or materials of the formula LiMFePO₄ wherein M is selected from the group consisting of Zr, Ti, Nb, Mg and Ca.

Electronically conductive fillers useful in the batteries of the present invention include materials such as carbon black, graphite, powdered nickel, metal particles, metal coated particles, conductive ceramics, conductive fibers, conductive polymers (e.g. characterized by a conjugated network of double bonds like polypyrrole and polyacetylene) and the like. A preferred electronic conductive filler is carbon black.

Current collectors are generally known in the battery art and any current collector useful in a battery can be used for preparing the batteries and cells of the present invention.

### EXAMPLES

Ethylene carbonate, propylene carbonate, diethyl carbonate and ethyl methyl carbonate are all commercially available solvents. EC, PC, DEC and EMC were mixed in the following weight ratios to obtain solvents useful in electrolytes. As a solute for the electrolyte lithium hexafluorophosphate was used so that a concentration of 1M was obtained.

Weight % (1 M LiPF₆)

| EC | PC | DEC | EMC |
|---|---|---|---|
| 60 | 5 | 10 | 25 |
| 60 | 5 | 5 | 30 |
| 60 | 5 | 25 | 10 |
| 66 | 0 | 0 | 33 |
| 60 | 0 | 20 | 20 |
| 60 | 0 | 10 | 30 |
| 60 | 0 | 30 | 10 |

Then film type polymeric batteries were prepared according to the following methodology. A free standing cathode film was laminated onto aluminum mesh and coated with an adhesion promoter. Similarly, a free standing anode film was laminated onto copper mesh and coated with an adhesion promoter. Portions of these assemblies were then punched out to make electrodes. Two anode electrodes and one cathode electrode were laminated with layers of separator between them to form an anode/separator/cathode/separator/anode cohesive assembly, known as a bicell. Alternatively, the bicell can be prepared using two cathodes and one anode. The full cell can also comprise one or more bicells welded together in parallel.

The cell was then extracted and dried. The electrolytes of the present invention were then added in an amount such that it was fully absorbed by the polymer, and no loose electrolyte remained in the cell. The cell was then hermetically sealed in a packaging material.

The charge discharge cycles were repeated 600 times under conditions that voltage for stopping charge and discharge were 3.65 V and 2.5 V respectively at a constant current of 2.6 A. The test was performed at 23° C.

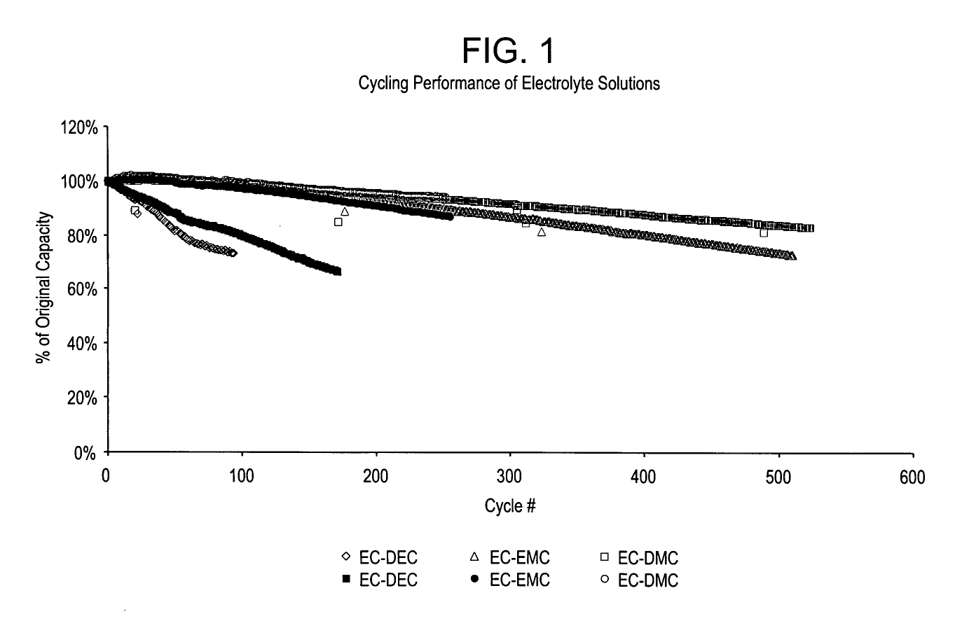

FIG. 1 shows the results of cycling tests with the above electrolytes. FIG. 1 shows that the cycle life of a cell using direct substitution of DEC for DMC is adversely affected, in that the capacity retained after 100 cycles is significantly reduced. It can be seen from FIG. 1 that the use of EMC in place of DMC has a smaller effect and has acceptable performance in some applications.

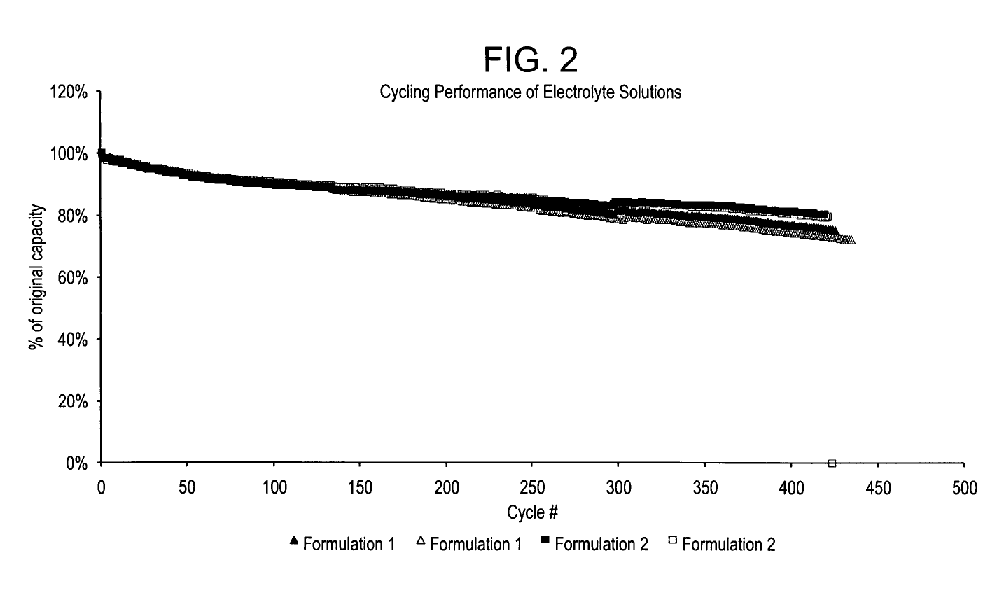

FIG. 2 shows that by using the preferred electrolytes formulations of the present invention that acceptable cycle life can be achieved even with removal of DMC from the solvent mixture.

Various modifications, substitutions and changes will be apparent to and can readily be made by those skilled in the art without departing from the scope and spirit of this invention. This description of the invention is merely exemplary in nature and, thus, variations that do not depart from the gist of the invention are intended to be within the scope of the invention.

We claim:

1. An electrolyte for used in a lithium cell or battery containing a lithium metal phosphate cathode wherein the electrolyte comprises a metal salt and ethyl methyl carbonate, propylene carbonate, diethyl carbonate and ethylene carbonate.

2. An electrolyte according to claim 1 wherein ethyl methyl carbonate is present in an amount from about 10 to about 80 wt %.

3. An electrolyte according to claim 2 wherein the ethylene carbonate is present in an amount from about 20 to about 80 wt %.

4. An electrolyte according to claim 3 wherein the propylene carbonate is present in an amount from about 0 to about 20 wt %.

5. An electrolyte according to claim 4 wherein the diethyl carbonate is present in an amount from about 0 to about 30 wt %.

6. An electrolyte according to claim 1 wherein the ethyl methyl carbonate is present in an amount from about 10 to about 40 wt %.

7. An electrolyte according to claim 6 wherein the ethylene carbonate is present in an amount from about 30 to about 70 wt %.

8. An electrolyte according to claim 6 wherein the ethylene carbonate is present in amount of about 50 to about 70 wt %.

9. An electrolyte according to claim 7 wherein the propylene carbonate is present in an amount from about 2 to about 10 wt %.

10. An electrolyte according to claim 9 wherein the propylene carbonate is present in an amount of about 5 wt %.

11. An electrolyte according to claim 9 wherein the diethyl carbonate is present in an amount from about 5 to about 30 wt %.

12. An electrolyte according to claim 1 wherein the ethylene carbonate is present in an amount of about 60 wt %; wherein the propylene carbonate is present in an amount of about 5 wt %; wherein the diethyl carbonate is present in an amount of about 10 wt % and wherein the ethyl methyl carbonate is present in an amount of about 25 wt %.

13. An electrolyte according to claim 1 wherein the ethylene carbonate is present in an amount of about 60 wt %; wherein the propylene carbonate is present in an amount of about 5 wt %; wherein the diethyl carbonate is present in an amount of about 25 wt % and wherein the ethyl methyl carbonate is present in an amount of about 10 wt %.

14. An electrolyte according to claim 1 wherein the ethylene carbonate is present in an amount of about 60 wt %; wherein the propylene carbonate is present in an amount of about 5 wt %; wherein the diethyl carbonate is present in an amount of about 5 wt % and wherein the ethyl methyl carbonate is present in an amount of about 30 wt %.

15. A lithium cell or battery comprising at least one positive electrode, and at least one counter negative electrode, such positive and negative counter electrodes alternately layered with separators interposed between such counter electrodes and an electrolyte dispersed therein wherein the positive electrode is comprised of a metal phosphate active material and wherein the electrolyte comprises a metal salt and a solvent mixture comprised of ethylene carbonate, propylene carbonate, diethyl carbonate and ethyl methyl carbonate.

16. A battery according to claim 15 wherein the positive electrode is comprised of LiMgₓFe₁₋ₓPO₄ wherein x is from about 0.01 to about 0.15.

17. A battery according to claim 15 wherein the positive electrode is comprised of a lithium vanadium phosphate active material.

18. A battery according to claim 15 wherein the ethyl methyl carbonate is present in an amount from about 10 to about 80 wt %.

19. A battery according to claim 18 wherein the ethylene carbonate is present in an amount from about 20 to about 80 wt %.

20. A battery according to claim 19 wherein the propylene carbonate is present in an amount from about 2 to about 20 wt %.

21. A battery according to claim 20 wherein the diethyl carbonate is present in an amount from about 2 to about 30 wt %.

22. A battery according to claim 15 wherein the ethyl methyl carbonate is present in an amount from about 10 to about 40 wt %.

23. A battery according to claim 22 wherein the ethylene carbonate is present in an amount from about 50 to about 70 wt %.

24. A battery according to claim 23 wherein the ethylene carbonate is present in an amount of about 60 wt %.

25. A battery according to claim 24 wherein the propylene carbonate is present in an amount from about 2 to about 10 wt %.

26. A battery according to claim 25 wherein the propylene carbonate is present in an amount of about 5 wt %.

27. A battery according to claim 26 wherein the diethyl carbonate is present in an amount from about 5 to about 30 wt %.

28. A battery according to claim 15 wherein the ethylene carbonate, propylene carbonate, diethyl carbonate, and ethyl methyl carbonate are present in amounts of about 60:5:10:25 wt %.

29. A battery according to claim 15 wherein the ethylene carbonate, propylene carbonate, diethyl carbonate, and ethyl methyl carbonate are present in amounts of about 60:5:25:10 wt %.

30. A battery according to claim 15 wherein the ethylene carbonate, propylene carbonate, diethyl carbonate and ethyl methyl carbonate are present in amounts of about 60:5:5:30 wt %.

31. A battery according to claim 16 wherein the ethyl methyl carbonate is present in an amount from about 10 to about 40 wt %.

32. A battery according to claim 31 wherein the ethylene carbonate is present in an amount from about 30 to about 70 wt %.

33. A battery according to claim 32 wherein the propylene carbonate is present in an amount from about 2 to about 20 wt %.

34. A battery according to claim 33 wherein the diethyl carbonate is present in an amount from about 2 to about 30 wt %.

35. A battery according to claim 16 wherein the ethyl methyl carbonate is present in an amount from about 10 to about 30 wt %.

36. A battery according to claim 35 wherein the ethylene carbonate is present in an amount from about 50 to about 70 wt %.

37. A battery according to claim 36 wherein the ethylene carbonate is present in an amount of about 60 wt %.

38. A battery according to claim 37 wherein the propylene carbonate is present in an amount from about 2 to about 10 wt %.

39. A battery according to claim 38 wherein the propylene carbonate is present in an amount of about 5 wt %.

40. A battery according to claim 39 wherein the diethyl carbonate is present in an amount from about 5 to about 30 wt %.

41. A battery according to claim 16 wherein the ethylene carbonate, propylene carbonate, diethyl carbonate, and ethyl methyl carbonate are present in amounts of about 60:5:10:25 wt %.

42. A battery according to claim 16 wherein the ethylene carbonate, propylene carbonate, diethyl carbonate, and ethyl methyl carbonate are present in amounts of about 60:5:25:10 wt %.

43. A battery according to claim 16 wherein the ethylene carbonate, propylene carbonate, diethyl carbonate and ethyl methyl carbonate are present in amounts of about 60:5:5:30 wt %.

44. A battery according to claim 17 wherein the ethyl methyl carbonate is present in an amount from about 10 to about 40 wt %.

45. A battery according to claim 44 wherein the ethylene carbonate is present in an amount from about 30 to about 70 wt %.

46. A battery according to claim 45 wherein the propylene carbonate is present in an amount from about 2 to about 20 wt %.

47. A battery according to claim 46 wherein the diethyl carbonate is present. in an amount from about 2 to about 30 wt %.

48. A battery according to claim 17 wherein the ethyl methyl carbonate is present in an amount from about 10 to about 30 wt %.

49. A battery according to claim 48 wherein the ethylene carbonate is present in an amount from about 50 to about 70 wt %.

50. A battery according to claim 49 wherein the ethylene carbonate is present in an amount of about 60 wt %.

51. A battery according to claim 50 wherein the propylene carbonate is present in an amount from about 2 to about 10 wt %.

52. A battery according to claim 51 wherein the propylene carbonate is present in an amount of about 5 wt %.

53. A battery according to claim 52 wherein the diethyl carbonate is present in an amount from about 5 to about wt 30 %.

54. A battery according to claim 17 wherein the ethylene carbonate, propylene carbonate, diethyl carbonate, and ethyl methyl carbonate are present in amounts of about 60:5:10:25 wt %.

55. A battery according to claim 17 wherein the ethylene carbonate, propylene carbonate, diethyl carbonate, and ethyl methyl carbonate are present in amounts of about 60:5:25:10 wt %.

56. A battery according to claim 17 wherein the ethylene carbonate, propylene carbonate, diethyl carbonate and ethyl methyl carbonate are present in amounts of about 60:5:5:30 wt %.

57. An electrolyte for use in a lithium battery or cell which contains a lithium metal phosphate cathode comprising methyl ethyl carbonate.

58. An electrolyte according to claim 57 further comprising ethylene carbonate.

59. An electrolyte according to claim 58 further comprising diethyl carbonate or dimethyl carbonate.

60. An electrolyte according to claim 57 further comprising diethyl carbonate.

61. The use of methyl ethyl carbonate in the electrolyte of a lithium battery or cell containing a lithium metal phosphate battery.
